(19) United States
(12) Patent Application Publication
(10) Pub. No.: US 2016/0364674 A1
(43) Pub. Date: Dec. 15, 2016

(54) PROJECT MANAGEMENT WITH CRITICAL PATH SCHEDULING AND RELEASING OF RESOURCES

(71) Applicant: MICROSOFT TECHNOLOGY LICENSING, LLC, Redmond, WA (US)

(72) Inventor: Lee Mark Macatangay, Bothell, WA (US)

(21) Appl. No.: 14/880,342

(22) Filed: Oct. 12, 2015

Related U.S. Application Data
(60) Provisional application No. 62/175,997, filed on Jun. 15, 2015.

(51) Int. Cl. G06Q 10/06

(52) U.S. Cl. CPC G06Q 10/063112; G06Q 10/06313

(57) ABSTRACT

Project management with critical path scheduling and releasing of resources may be provided. In some examples, an application, such as a project management application may receive tasks associated with a project. A subset of the tasks to be categorized as mission-critical tasks may be detected. Resources associated with the mission-critical tasks may be determined. The project management application may evaluate the resources associated with the mission-critical tasks to determine if the resources meet predefined qualifications for the mission-critical tasks.

### CROSS-REFERENCE TO RELATED APPLICATION

This Application is a non-provisional under 35 U.S.C §119(e) of co-pending U.S. Provisional Application No. 62/175,997 filed on Jun. 15, 2015. The U.S. Provisional Application is herein incorporated by reference in its entirety.

### BACKGROUND

Many operations may be defined and structured as projects. Within a structured project, designated people may develop plans, assign resources to tasks, track progress of the tasks, manage budgets associated with the project, and analyze progress/workloads associated with the tasks. Project management applications may enable people to create critical path schedules and resource allocations in a manual, automated, or semi-automated manner. Schedules, the resource allocations, and other aspects of the project may be visualized in different ways. Some project management applications also provide additional views such as calendars, tables, etc. The project management applications may be executed by project management services to enable people to track progress of individual tasks, as well as track the progress of the overall project.

Typical project management applications are relatively complex programs that can interact with other applications, like Enterprise Resource Planning (ERP) applications, to integrate project management with other aspects of the organizations such as inventory, marketing, customer service, and similar ones. Numerous projects in real world scenarios may fail because of errors in managing resources, and in such scenarios, implicit errors may be difficult to find and correct. One such implicit error is having a resource assigned to a task that is not fully capable of successfully delivering the task due to conflicts, priorities or competence, or a highly skilled resource is moved around to different tasks, losing its focus on the mission-critical tasks.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing project management with critical path scheduling and releasing of resources. In some examples, an application, such as a project management application, may receive tasks associated with a project. A subset of the tasks to be categorized as mission-critical tasks may be detected. Resources associated with the mission-critical tasks may be determined. The project management application may evaluate the resources associated with the mission-critical tasks to determine if the resources meet predefined qualifications for the mission-critical tasks.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example computing environment for providing project management with critical path scheduling and releasing of resources, according to embodiments;

FIG. 2 is a conceptual diagram illustrating an example project management system that provides project management with critical path scheduling and releasing of resources, according to embodiments;

FIG. 3 illustrates a project management interface of a project management application displaying a project, according to embodiments;

FIG. 4 illustrates tasks and mission-critical tasks associated with providing project management with critical path scheduling and releasing of resources, according to embodiments;

FIG. 5 is a simplified networked environment, where a system according to embodiments may be implemented;

FIG. 6 is a block diagram of an example computing device, which may be used to provide project management with critical path scheduling and releasing of resources, according to embodiments; and

FIG. 7 is a logic flow diagram illustrating a process to provide project management with critical path scheduling and releasing of resources, according to embodiments.

### DETAILED DESCRIPTION

As briefly described above, project management with critical path scheduling and releasing of resources may be provided. In some examples, an application, such as a project management application, may receive tasks associated with a project. A subset of the tasks to be categorized as mission-critical tasks may be detected. Resources associated with the mission-critical tasks may be determined. The project management application may evaluate the resources associated with the mission-critical tasks to determine if the resources meet predefined qualifications for the mission-critical tasks.

The project management application may distinguish information associated with the mission-critical tasks by a textual scheme, a graphical scheme, an audio scheme, an animation scheme, a coloring scheme, a highlighting scheme, and a shading scheme, among others. The information may be displayed as a presentation of the mission-critical tasks on a project management interface of a display device. The resources may be displayed adjacent to the presentation of the mission-critical tasks on the project management interface. The resources may include an identity of a stakeholder performing the task, a physical resource performing the task, and a virtual resource performing the task, among others.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing project management with critical path scheduling and releasing of resources. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that allow the application or service to interact or communicate with one or more other applications and services managed by separate entities.

While example implementations are described using projects herein, embodiments are not limited to projects. Providing project management with critical path scheduling and releasing of resources may be implemented in other environments, such as instant messages, data sharing, application sharing, online conferencing, and similar communications, where project data may be exchanged.

The technical advantages of providing project management with critical path scheduling and releasing of resources may include, among others, increased efficiency of the stakeholder interactions through critical task information presentation. Furthermore, project management tasks may be easily replaced, moved, removed with minimal impact on project outcome. Processing and network bandwidth usage may also be reduced by avoiding repeated project flow changes, for example when tasks or resources have to be re-allocated. Project planning and initial establishment of the tasks may also be optimized through the additional critical task and resource information resulting in reduced memory and processor burden during the initial phases of project planning.

Embodiments address a need that arises from very large scale of operations created by networked computing and cloud based services that cannot be managed by humans. The actions/operations described herein are not a mere use of a computer, but address results of a system that is a direct consequence of software used as a service such as communication services offered in conjunction with the projects.

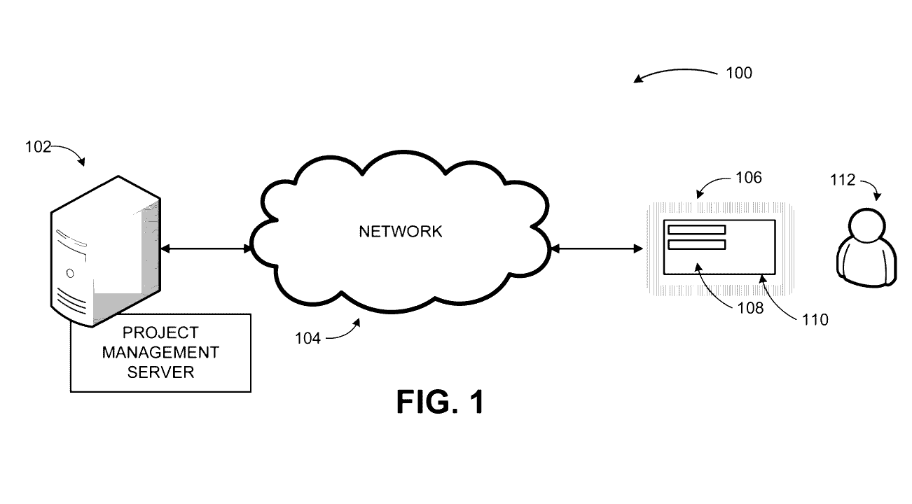

FIG. 1 is a conceptual diagram illustrating an example computing environment for providing project management with critical path scheduling and releasing of resources, according to embodiments.

As shown in a diagram 100, a computing device 106 may execute a project management application 110. The project management application 110 may receive tasks associated with a project from a project management server 102. The project management application 110 may compile project data associated with the project and tasks associated with the project. The project management application 110 may analyze scenarios associated with the tasks and may visualize various aspects of the project, such as schedules, resource allocations, and similar ones using visual tools like Gantt charts, calendars, tables, and comparable ones. The computing device 106 may include a display device, such as a touch enabled display component, and a monitor, among others, to provide the project management application 110 to a stakeholder 112. The computing device 106 may include a desktop computer, a laptop computer, a tablet, a smart phone, and a wearable computer, among other similar computing devices, for example.

In some examples, the project management application 110 may be executed on the project management server 102. The project management server 102 may include a web server or a document server, among others. The computing device 106 may communicate with the project management server 102 through a network 104. The network 104 may provide wired or wireless communications between nodes, such as the computing device 106 or the project management server 102. In other examples, the project management application 110 may be provided by a third party service, web applications, and/or a datacenter, among others. Local access to the project management application 110 may be provided by locally installed rich clients (a local version of the project management application 110) or generic applications, such as a browser on the computing device 106.

The project management application 110 executed on the project management server 102 represents a visual way to view and track statues of the tasks. The project management application 110 may visualize the tasks employing a grid of columns reflecting the state of a given task (e.g., not started, in progress, ready for testing signoff, completed, etc.) and rows representing aggregations of tasks (summary tasks, or “stories”). The tasks may be represented by graphical objects, textual objects, or a combination of the graphical objects and the textual objects on the grid. The project management application 110 may implement various graphical, textual, coloring, shading, and similar schemes to emphasize different aspects of the statuses of the tasks, the tasks, the resources associated with the tasks, and information associated with the tasks, among other properties.

In some examples, the information, the tasks, and the resources may be displayed as a presentation on a project management interface 108 of the computing device 106. Furthermore, conventional and intrinsic project management fields, such as a percentage complete, may be used for automatic placement of specific tasks into appropriate columns on the project management interface 108. In some examples, the project management application 110 may enable the stakeholder 112 to create critical path schedules for the tasks.

The project management application 110 may detect a subset of the tasks to be categorized as mission-critical tasks and may determine the resources associated with the mission-critical tasks. The stakeholder 112 may also be allowed to allocate the resources associated with the tasks in a manual, automated, or semi-automated manner. The project management application 110 may evaluate the resources associated with the mission-critical tasks to determine if the resources meet predefined qualifications for the mission-critical tasks.

While the example system in FIG. 1 has been described with specific components including the computing device 106, the project management application 110, and the project management server 102, embodiments are not limited to these components or system configurations and can be implemented with other system configuration employing fewer or additional components.

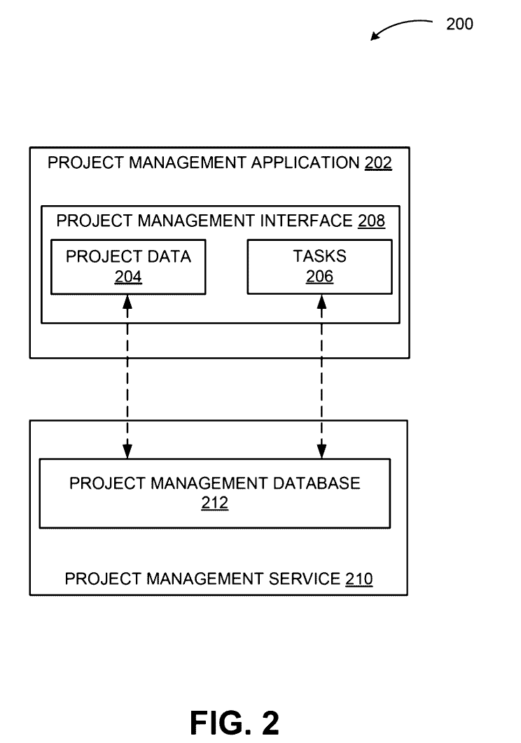

FIG. 2 is a conceptual diagram illustrating an example project management system that provides project management with critical path scheduling and releasing of resources, according to embodiments.

In a diagram 200, a project management application 202 may retrieve projects from a project management database 212. The projects are a linear time period in which tasks 206, resources, and project data 204 may be assigned and related to each other. The project management database 212 may be associated with a project management service 210. In other examples, the project management database 212 may be hosted by a project management server.

Upon association of the project management application 202 with the project management service 210, the project management application 202 may import the project data 204, documents associated with the projects, the projects, and the tasks 206 associated with the projects from the project management database 212. If existing project data 204 associated with the projects cannot be imported from the project management database 212, a new project may be created using the tasks 206 as a source for the project data 204.

A project management interface 208 of the project management application 202 may display the project data 204, the tasks 206, and the projects to a stakeholder. The stakeholder may have access to the projects using the project management interface 208. The stakeholder may view the projects stored in the project management database 212 over the project management interface 208. Depending on the viewing mode, the stakeholder may additionally have control and project management capabilities over the projects in the project management interface 208. In a further embodiment, the stakeholder may create a profile on the project management application 202 for access to the projects in the project management database 212. The project management application 202 may also enable the stakeholder to view and edit the projects using the project management interface 208.

In some examples, the projects may be identified in the project management application 202 by project names, by the resources associated with the projects, by the information associated with the projects, and by the tasks 206 associated with the projects, among others. The resources may include an identity of the stakeholder performing the task, a physical resource performing the task, and a virtual resource performing the task, among others. The project management application 202 may also enable the stakeholder to utilize the project management interface 208 to search for another project. If the other project is identified, the project management application 202 may collect and import the other project, the project data 204 of the other project, and the tasks 206 associated with the other project.

In some examples, the project management application 202 may allow the stakeholder to select the project. The project, the project data 204, and the tasks 206 may be imported from the project management database 212 into the project management application 202. In other examples, association of the projects, the project data 204, and the tasks 206 with the project management application 202 may occur in response to opening the project management application 202. The projects, the project data 204, and the tasks 206 may be continuously synchronized between the project management application 202 and the project management database 212.

In a system according to embodiments, while the initial association of the project management application 202 and the project management interface 208 occurs, application functionality may remain enabled such that the stakeholder may access and control the projects, the project data 204 and the tasks 206 in the project management application 202. As updates and modifications are made to the projects, the project data 204, and the tasks 206, the updates may be transmitted to the project management database 212.

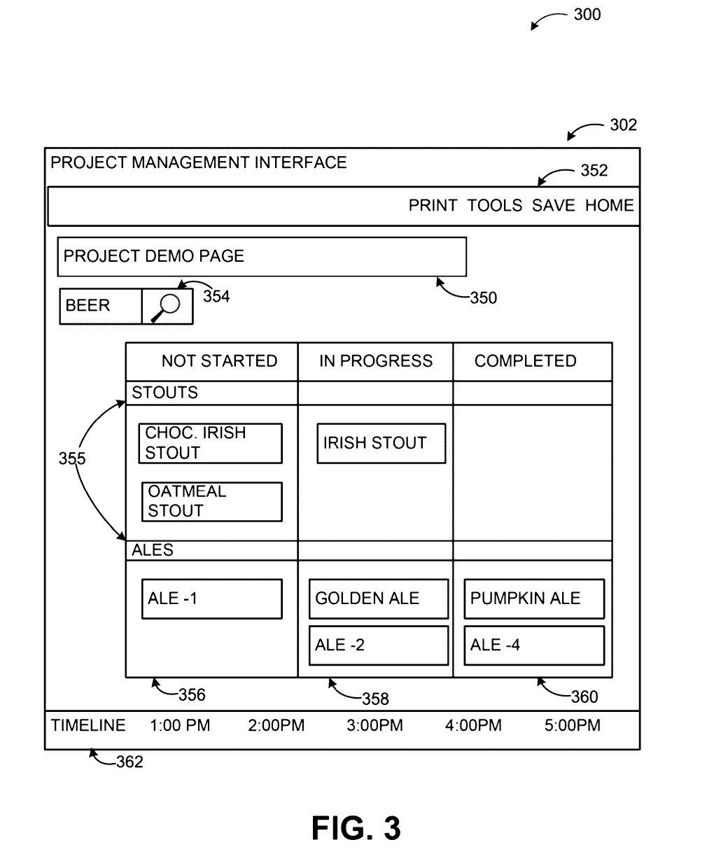

FIG. 3 illustrates a project management interface of a project management application displaying a project, according to embodiments.

In a diagram 300, a project management interface 302 of a project management application may display project data, tasks 355, resources, and information associated with projects to a stakeholder. The project management application may perform various computations, analyses, and visualization operations associated with the resources and the projects. The project management application may be a separate application executed locally or may be a hosted service, which may be accessed through a generic client application. In examples, a browser may be used to access the project management application through the project management interface 302.

The project management application may allow the stakeholder to identify a project in a project box 354. In some examples, the project may be selected through use of a drop-down menu or a textual entry box, among others. In response to the identification of the project in the project box 354, the project may be displayed on the project management interface 302. The project management application may include browser controls 352 (graphical and/or textual control elements) to allow the stakeholder to perform actions on the selected project. The actions may include editing, copying, and scheduling of the resources, the project data, and information associated with the selected project. The project management application may further include a title 350 to identify the project.

The tasks 355 associated with the project may be listed in a first status column 356 hierarchically distinguished from the tasks 355 (or sub-tasks) in the same column. Other tasks 355 may be displayed in a second status column 358 and a third status column 360, following the same hierarchical tree scheme. Summary tasks may also be displayed in the first status column 356, the second status column 358, and the third status column 360.

A summary task may be defined as a task that has one or more children tasks. The summary tasks may have the children tasks that are themselves summary tasks. A child task may be any task that has no children reporting to it. The children tasks are also referred to as the sub-tasks herein.

The first status column 356, the second status column 358, and the third status column 360 may be determined based on a selection by the stakeholder of predefined status categories or by a stakeholder definition for the categories. An automatic mapping may be performed to translate the project management fields to the status columns. For example, a zero in the percent complete field may be translated as “Not Started”, any value between 1 and 99 may be translated as “In Progress”, and a one hundred in the percent complete field may be translated as “Completed.”

In other examples, the mapping of the task statues from project fields to the columns in the project management interface 302 of the project management application may occur through a predefined or stakeholder-specific filter. The predefined or stakeholder-specific filter may include rules. A rule may indicate, “the tasks with zero percent complete and starting less than today are to be placed in a column title To Do.” An algorithm facilitating the transformation may evaluate each task within each summary task to determine the column the task fits in based on the filter (rule or combination of rules). In response to the evaluation of the tasks 355, the project management application may move the tasks 355 to the respective column.

The columns may be determined by a task property unrelated to the status of the task. For example, each task may have a field called “team”, with values like “Red Team”, “Green team”, etc. The fields and values associated with the tasks 355 may be displayed visually on the project management interface 302. The fields and values may be updated by the same drag-and-drop mechanisms discussed herein. Such a configuration is a hybrid critical path method based project system because the task data may also appear in the critical path method centric views of the project management application.

In some examples, the tasks 355 may be displayed using graphical objects and/or textual identification. A coloring scheme or shading scheme may be employed to further identify a property of each task (i.e., a sub-status such as percentage for “In Progress” tasks). Some or all of the displayed elements on the project management interface 302 may be actionable. For example, the project management application may provide links to controls associated with setting parameters and/or modification parameters of the tasks 355. In some examples, the links may be associated with modifying view settings of the project on the project management interface 302. In some examples, a timeline 362 may be present on the project management application. The timeline may display a time and/or a date based temporal reference for the progress of the tasks displayed.

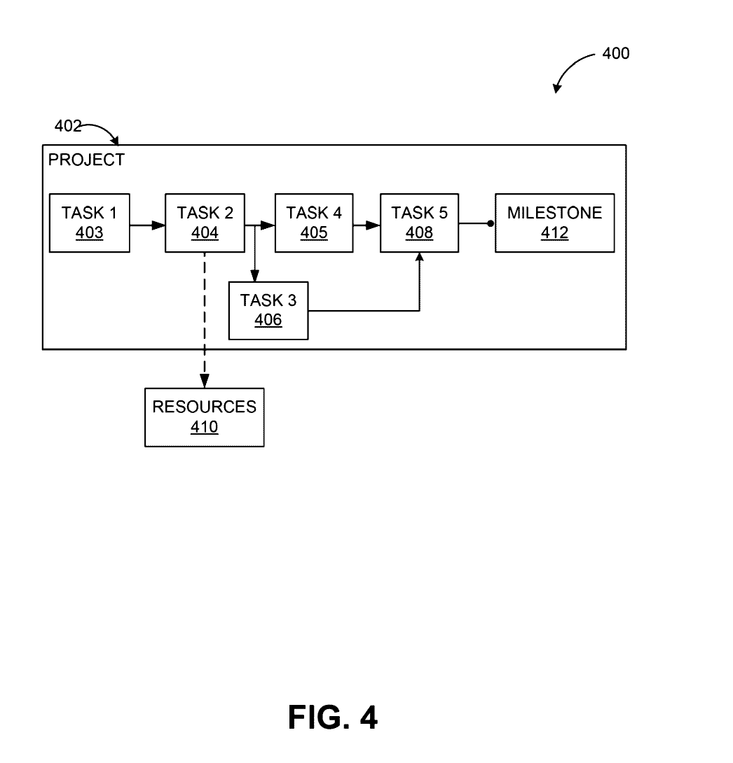

FIG. 4 illustrates tasks and mission-critical tasks associated with providing project management with critical path scheduling and releasing of resources, according to embodiments.

In a diagram 400, a project 402 may be displayed on a project management interface of a project management application. The project 402 may display connections between a first task 403, a second task 404, a third task 406, a fourth task 405, and a fifth task 408. In examples, the project management application may detect a subset of the tasks to be categorized as mission-critical tasks based on information and resources 410 associated with the tasks. In the diagram 400, for example, the second task 404 is identified as a first mission-critical task and the fourth task 405 is identified as a second mission-critical task.

The mission-critical tasks may be executed by the project management application in response to a determination that the resources 410 meet the predefined qualifications. In some examples, the project management application may evaluate the resources 410 to determine if the resources 410 meet from about 95% to about 100% of the predefined qualifications for the mission-critical tasks. The mission-critical tasks are the subset of the tasks that need to be completed to achieve a milestone 412. The milestone 412 is a point of transition from a first phase of the project 402 to another phase of the project 402.

In some examples, the project management application may perform a verification process during the association of the resources 410 with the mission-critical tasks to determine if a first resource associated with the first mission-critical task (i.e. the second task 404) is additionally allocated to the second mission-critical task (i.e. the fourth task 405). In response to a determination from the verification process that the first resource is allocated to the second mission-critical task (i.e. the fourth task 405), the project management application may release the first resource from the second mission-critical task (i.e. the fourth task 405). Once a completion of the first mission-critical task (i.e. the second task 404) is detected, the project management application may re-assign the first resource to the second mission-critical task (i.e. the fourth task 405).

In other examples, the project management application may perform the verification process while the resources 410 are associated and/or assigned to the mission-critical tasks. During a first time period, for example, the resources 410 are not assigned to the first mission-critical task (i.e. the second task 404). The project management application may run the verification process during a second time period when the resources 410 are being assigned to the first mission-critical task (i.e. the second task 404). The verification process may determine if the resources 410 meet predefined qualifications of the first mission-critical task (i.e. the second task 404). If the project management application determines that the resources 410 meet the predefined qualifications of the first mission-critical task (i.e. the second task 404), the project management application may assign the resources to the first mission-critical task (i.e. the second task 404). If the project management application determines that the resources 410 fail to meet the predefined qualifications of the first mission-critical task (i.e. the second task 404), the project management application may transmit an alert to a display device to prompt the display device to present the alert. The alert may inform the user that the resources cannot be assigned to the first mission-critical task (i.e. the second task 404). The alert may include an audio alert, a visual alert, a tactile alert, and a textual alert, among others.

The project management application may distinguish information associated with the mission-critical tasks. In some examples, the project management application may display the information as a presentation of the mission-critical tasks on the project management interface. The resources 410 may be displayed adjacent to the presentation of the mission-critical tasks on the project management interface.

In examples, the project management application may provide the information associated with the mission-critical tasks to a stakeholder. The information associated with the mission-critical tasks may be distinguished based on stakeholder-defined criteria. The stakeholder-defined criteria may include a type of the mission-critical tasks, a time period for performing the mission-critical tasks, a progress of the mission-critical tasks, and a type of the project 402 associated with the mission-critical tasks, among others. The information may be displayed as the presentation of the mission-critical tasks on the project management interface.

In some examples, the project management application may compute a threshold to determine if the resources 410 meet the predefined qualifications for the mission-critical tasks. The predefined qualifications may include certifications to complete the mission-critical tasks and a prior history of completing the mission-critical tasks, among others. The project management application may determine that the resources 410 meet the predefined qualifications for the mission-critical tasks. In response to the determination, the project management application may detect an assignment of the resources 410 to the mission-critical tasks during a time period and may prevent the assigned resources 410 from being allocated to another task during the time period. The project management application may also prevent the assigned resources 410 from overlapping with the other task during the time period.

If the project management application determines that the resources 410 fail to meet the predefined qualifications for the mission-critical tasks, the resources 410 may be released from the mission-critical tasks. If the resources 410 are released from the mission-critical tasks, the project management application may transmit the alert to a display device to prompt the display device to present the alert.

In some examples, the project management application may detect a completion of a final task (i.e. the fifth task 408) prior to completion of one of the mission-critical tasks (i.e. the second task 404 or the fourth task 405). The milestone 412 associated with the tasks may be marked as a failure. The project management application, in other examples, may detect a delay in a performance of one of the mission-critical tasks (i.e. the second task 404 or the fourth task 405). The project management application may mark the milestone 412 associated with the tasks as the failure.

In further examples, the project management application may enable the stakeholder to move a first resource from a first mission-critical task (i.e. the second task 404) to a second mission-critical task (i.e. the fourth task 405). The project management application may determine that the first resource meets the predefined qualifications. The project management application may prompt the stakeholder to accept or reject proposed consequences associated with the movement of the first resource to the second mission-critical task (i.e. the fourth task 405). The project management application may receive an acceptance of the proposed consequences and may execute the second mission-critical task (i.e. the fourth task 405).

In another example, the project management application may enable the stakeholder to release a first resource from a first mission-critical task (i.e. the second task 404) based on a determination that the first resource fails to possess certifications to complete the first mission-critical task (i.e. the second task 404) or includes a conflict that disallows the first resource from completing the first mission-critical task (i.e. the second task 404). The stakeholder may be prompted to accept or reject proposed consequences associated with the release of the first resource from the first mission-critical task (i.e. the second task 404). The project management application may receive an acceptance of the proposed consequences from the stakeholder and may execute the first mission-critical task (i.e. the second task 404).

The example scenarios and schemas in FIG. 1 through FIG. 4 are shown with specific components, data types, and configurations. Embodiments are not limited to systems according to these example configurations. Critical path scheduling and releasing of resources may be implemented in configurations employing fewer or additional components in applications and user interfaces. Furthermore, the example schema and components shown in FIG. 1 through FIG. 4 and their subcomponents may be implemented in a similar manner with other values using the principles described herein.

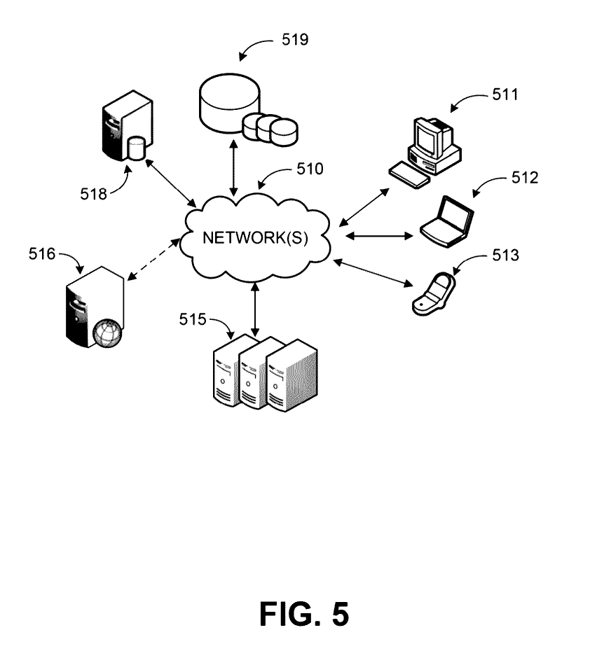

FIG. 5 is an example networked environment, where a system according to embodiments may be implemented.

As shown in a diagram 500, project operations, such as planning, execution, re-allocations, and similar ones may be performed by a project management application. In examples, a project management service may be implemented via software executed over the servers 514. The platform may communicate with client applications on individual computing devices such as a smart phone 513, a mobile computer 512, or desktop computer 511 (‘client devices’) through network(s) 510. The servers 514, may include one or more project management servers 516, where at least one of the one or more project management servers 516 may be configured to execute one or more applications (i.e. the project management application) associated with the project management service. In other examples, the project management service may be provided by a third party service or may include a web application. The project management service may store data associated with project data in a data store 519 directly or through a database server 518. Client applications executed on client devices 511-513 may be enabled to receive the project data and render the project management interface displaying the project information along with critical task related information.

Client applications executed on any of the client devices 511-513 may facilitate communications via application(s) executed by the one or more project management servers 516, or on an individual project management server. An application, such as the project management application, may receive tasks associated with a project and may detect a subset of the tasks to be categorized as mission-critical tasks. Resources associated with the mission-critical tasks may be determined. The resources associated with the mission-critical tasks may be evaluated to determine if the resources meet predefined qualifications for the mission-critical tasks. The project management application may store the project data associated with the projects in the data store 519 directly or through database server 518.

The network(s) 510 may comprise any topology of servers, clients, Internet service providers, and communication media. A system according to embodiments may have a static or dynamic topology. The network(s) 510 may include secure networks such as an enterprise network, an unsecure network such as a wireless open network, or the Internet. The network(s) 510 may also coordinate communication over other networks such as Public Switched Telephone Network (PSTN) or cellular networks. Furthermore, the network(s) 510 may include short range wireless networks such as Bluetooth or similar ones. The network(s) 510 provide communication between the nodes described herein. By way of example, and not limitation, the network(s) 510 may include wireless media such as acoustic, RF, infrared and other wireless media.

A textual scheme, a graphical scheme, an audio scheme, an animation scheme, a coloring scheme, a highlighting scheme, and/or a shading scheme may be employed to further enhance stakeholder interaction between the project data and the provided project view.

Many other configurations of computing devices, applications, data sources, and data distribution systems may be employed to provide project management with critical path scheduling and releasing of resources. Furthermore, the networked environments discussed in FIG. 5 are for illustration purposes only. Embodiments are not limited to the example applications, modules, or processes.

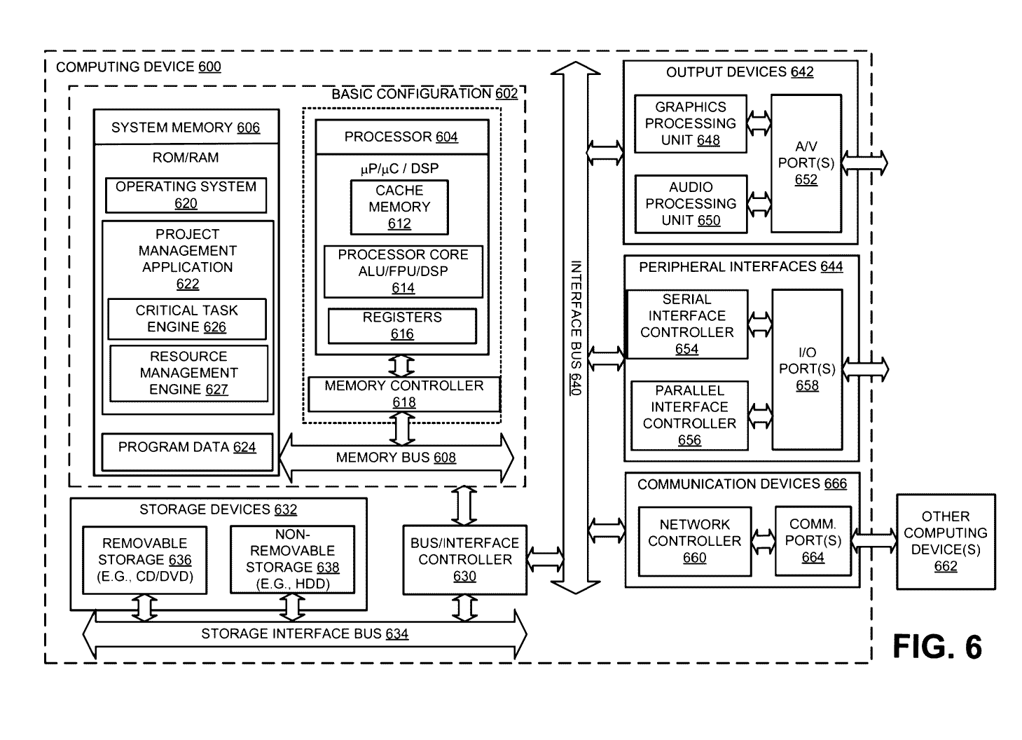

FIG. 6 is a block diagram of an example computing device, which may be used to provide project management with critical path scheduling and releasing of resources, according to embodiments.

For example, a computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The example basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The one or more processor cores 614 may (each) include an arithmetic logic unit (ALU), a floating point unit (FPU), a digital signal processing core (DSP Core), or any combination thereof. An example memory controller 618 may also be used with the processor 604, or in some implementations, the example memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a project management application 622, and a program data 624. The project management application 622 may include a critical task engine 626 and a resource management engine 627. The critical task engine 626 may receive tasks associated with a project. The critical task engine 626 may detect a subset of the tasks to be categorized as mission-critical tasks may determine resources associated with the mission-critical tasks. The resource management engine 627 may evaluate the resources associated with the mission-critical tasks to determine if the resources meet predefined qualifications for the mission-critical tasks.

Components of the project management application 622 (such as a project management interface) may also be displayed on a display device associated with the computing device 600. An example of the display device may include a hardware screen that may be communicatively coupled to the computing device 600. The display device may include a touch based device that detects gestures such as a touch action. The display device may also provide feedback in response to detected gestures (or any other form of input) by transforming a user interface of the project management application 622, displayed by the touch based device. The program data 624 may also include, among other data, the project data or the like, as described herein.

The computing device 600 may have additional features or functionality, and additional interfaces to facilitate communications between the example basic configuration 602 and any desired devices and interfaces. For example, a bus/interface controller 630 may be used to facilitate communications between the example basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the example basic configuration 602 via the bus/interface controller 630. Some of the one or more output devices 642 include a graphics processing unit 648 and an audio processing unit 650, which may be configured to communicate to various external devices such as a display or speakers via one or more A/V ports 652. The one or more peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide project management with critical path scheduling and releasing of resources. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

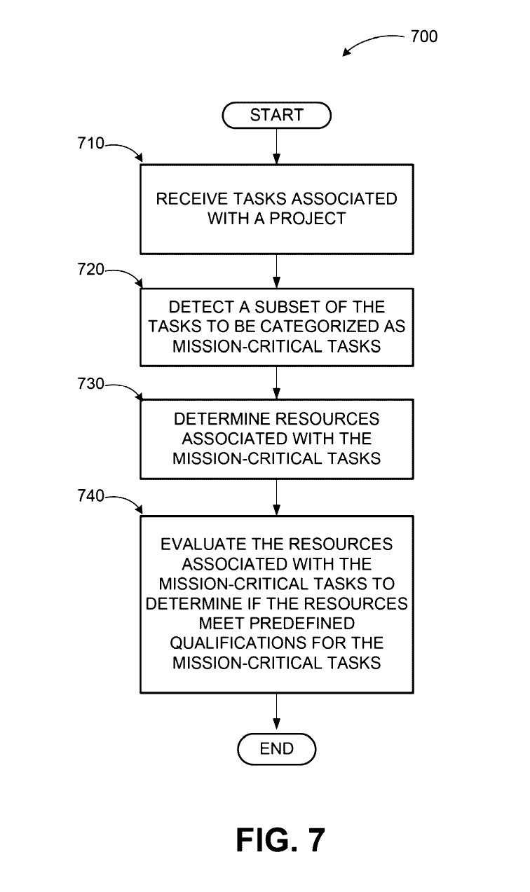

FIG. 7 is a logic flow diagram illustrating a process to provide project management with critical path scheduling and releasing of resources, according to embodiments.

A process 700 may be implemented on a computing device, such as the computing device 600, or with another system. As described, a stakeholder may be allowed to interact with a project management application through an input device or a touch enabled display component of the computing device 600. The computing device 600 may include a display device to provide a project management interface of the project management application to the stakeholder.

The process 700 begins with operation 710, where the project management application may receive tasks associated with a project. At operation 720, the project management application may detect a subset of the tasks to be categorized as mission-critical tasks. The project management application may distinguish information associated with the mission-critical tasks. In other examples, the project management application may provide information associated with the mission-critical tasks to the stakeholder. The information associated with the mission-critical tasks may be distinguished based on stakeholder-defined criteria. The project management application may display the information as a presentation of the mission-critical tasks on a project management interface of a display device.

At operation 730, the project management application may determine resources associated with the mission-critical tasks. In examples, the project management application may compute a threshold to determine if the resources meet the predefined qualifications for the mission-critical tasks.

At operation 740, the project management application may evaluate the resources associated with the mission-critical tasks to determine if the resources meet predefined qualifications for the mission-critical tasks. The evaluation process may include determining that the resources meet from about 95% to about 100% of the predefined qualifications for the mission-critical tasks. In examples, in response to a determination that the resources meet the predefined qualifications for the mission-critical tasks, the project management application may detect an assignment of the resources to the mission-critical tasks during a time period. The project management application may also prevent the assigned resources from being allocated to another task during the time period and prevent the assigned resources from overlapping with the other task during the time period. In response to a determination that the resources fail to meet the predefined qualifications for the mission-critical tasks, the project management application may release the resources from the mission-critical tasks and may transmit an alert to a display device to prompt the display device to present the alert.

The operations included in process 700 are for illustration purposes. Providing project management with critical path scheduling and releasing of resources may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some embodiments, a means for providing project management with critical path scheduling and releasing of resources may include a means for receiving tasks associated with a project, a means for detecting a subset of the tasks to be categorized as mission-critical tasks, a means for determining resources associated with the mission-critical tasks, and a means for evaluating the resources associated with the mission-critical tasks to determine if the resources meet predefined qualifications for the mission-critical tasks.

According to some examples, computing devices to provide project management with critical path scheduling and releasing of resources are described. An example computing device may include a memory and processors coupled to the memory. The processors may execute a project management application within a project management service in conjunction with instructions stored in the memory. The project management application may include a critical task engine and a resource management engine. The critical task engine may be configured to receive tasks associated with a project, detect a subset of the tasks to be categorized as mission-critical tasks, and determine resources associated with the mission-critical tasks. The resource management engine may be configured to evaluate the resources associated with the mission-critical tasks to determine if the resources meet predefined qualifications for the mission-critical tasks.

According to other examples, the critical task engine may be further configured to distinguish information associated with the mission-critical tasks through use a textual scheme, a graphical scheme, an audio scheme, an animation scheme, a coloring scheme, a highlighting scheme, and/or a shading scheme. The critical task engine may be further configured to display the information as a presentation of the mission-critical tasks on a project management interface of a display device. The critical task engine may be further configured to display the resources adjacent to the presentation of the mission-critical tasks on the project management interface. The resources may include an identity of a stakeholder performing the task, a physical resource performing the task, and/or a virtual resource performing the task.

According to further examples, the critical task engine may be further configured to provide information associated with the mission-critical tasks to a stakeholder. The critical task engine may be further configured to distinguish the information associated with the mission-critical tasks based on stakeholder-defined criteria. The stakeholder-defined criteria may include a type of the mission-critical tasks, a time period for performing the mission-critical tasks, a progress of the mission-critical tasks, and/or a type of the project associated with the mission-critical tasks. The critical task engine may be further configured to display the information as a presentation of the mission-critical tasks on a project management interface of a display device.

According to some examples, the resource management engine may be further configured to compute a threshold to determine if the resources meet the predefined qualifications for the mission-critical tasks. The predefined qualifications may include certifications to complete the mission-critical tasks and/or a prior history of completing the mission-critical tasks. In some examples, the resource management engine may be further configured to determine that the resources meet the predefined qualifications of the mission-critical tasks, detect an assignment of the resources to the mission-critical tasks during a time period, prevent the assigned resources from being allocated to another task during the time period, and prevent the assigned resources from overlapping with the other task during the time period. In other examples, the resource management engine may be further configured to determine that the resources fail to meet the predefined qualifications for the mission-critical tasks, release the resources from the mission-critical tasks, and transmit an alert to a display device to prompt the display device to present the alert. The alert may include an audio alert, a visual alert, a tactile alert, and/or a textual alert.

According to further examples, the resource management engine may be further configured to detect a completion of a final task prior to completion of one of the mission-critical tasks and mark a milestone associated with the tasks as a failure. The milestone may be a point of transition from a first phase of the project to another phase of the project. In other examples, the resource management engine may be further configured to detect a delay in a performance of one of the mission-critical tasks and mark a milestone associated with the tasks as a failure.

According to some embodiments, methods executed on a computing device to provide project management with critical path scheduling and releasing of resources are provided. An example method may include receiving tasks associated with a project, detecting a subset of the tasks to be categorized as mission-critical tasks, distinguishing information associated with the mission-critical tasks, determining resources associated with the mission-critical tasks, and evaluating the resources associated with the mission-critical tasks to determine if the resources meet predefined qualifications for the mission-critical tasks.

According to some examples, the example method may further include performing a verification process during an association of the resources with the mission-critical tasks to determine if a first resource associated with a first mission-critical task is additionally allocated to a second mission-critical task. In some examples, the example method may further include determining from the verification process that the first resource is allocated to the second mission-critical task, releasing the first resource from the second mission-critical task, detecting a completion of a first mission-critical task, and re-assigning the first resource to the second-mission critical task.

According to further examples, the example method may further include executing the mission-critical tasks in response to a determination that the resources meet the predefined qualifications. In some examples, the example method may further include enabling a stakeholder to move a first resource from a first mission-critical task to a second mission-critical task, determining that the first resource meets the predefined qualifications, receiving a notification of proposed consequences of a movement of the first resource to the second mission-critical task, receiving an acceptance of the proposed consequences, and executing the second mission-critical task.

According to other examples, the example method may further include enabling a stakeholder to release a first resource from a first mission-critical task based on a determination that the first resource fails to possess certifications to complete the first mission-critical task or includes a conflict that disallows the first resource from completing the first mission-critical task. The example method may further include receiving a notification of proposed consequences of the release of the first resource from the first mission-critical task, receiving an acceptance of the proposed consequences, and releasing the first resource from the first mission-critical task. In further examples, evaluating the resources associated with the mission-critical tasks may further include determining that the resources meet from about 95% to about 100% of the predefined qualifications for the mission-critical tasks.

According to some examples, computer-readable memory devices with instructions stored thereon to provide project management with critical path scheduling and releasing of resources are described. Example instructions may include receiving tasks associated with a project, detecting a subset of the tasks to be categorized as mission-critical tasks, distinguishing information associated with the mission-critical tasks, determining resources associated with the mission-critical tasks, and evaluating the resources associated with the mission-critical tasks to determine if the resources meet predefined qualifications for the mission-critical tasks.

According to further examples, the instructions may further include performing a verification process during an association of the resources with the mission-critical tasks to determine if a first resource associated with a first mission-critical task is additionally allocated to a second mission-critical task. The instructions may further include determining from the verification process that the first resource is allocated to the second mission-critical task, releasing the first resource from the second mission-critical task, detecting a completion of the first mission-critical task, and re-assigning the first resource to the second-mission critical task.

According to some examples, the instructions may further include performing a verification process during an association of the resources with the mission-critical tasks, determining from the verification process that the resources meet predefined qualifications of the mission-critical tasks, and assigning the resources to the mission-critical tasks.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide project management with critical path scheduling and releasing of resources, the computing device comprising:
a memory;
one or more processors coupled to the memory, the one or more processors executing a project management application within a project management service in conjunction with instructions stored in the memory, wherein the project management application includes:
a critical task engine configured to:
receive tasks associated with a project;
detect a subset of the tasks to be categorized as mission-critical tasks; and
determine resources associated with the mission-critical tasks; and
a resource management engine configured to:
evaluate the resources associated with the mission-critical tasks to determine if the resources meet predefined qualifications for the mission-critical tasks.

2. The computing device of claim 1, wherein the critical task engine is further configured to:
distinguish information associated with the mission-critical tasks through use of one or more of a textual scheme, a graphical scheme, an audio scheme, an animation scheme, a coloring scheme, a highlighting scheme, and a shading scheme;
display the information as a presentation of the mission-critical tasks on a project management interface of a display device; and
display the resources adjacent to the presentation of the mission-critical tasks on the project management interface, wherein the resources include one or more of: an identity of a stakeholder performing the task, a physical resource performing the task, and a virtual resource performing the task.

3. The computing device of claim 1, wherein the critical task engine is further configured to:
provide information associated with the mission-critical tasks to a stakeholder;
distinguish the information associated with the mission-critical tasks based on stakeholder-defined criteria, wherein the stakeholder-defined criteria includes one or more of a type of the mission-critical tasks, a time period for performing the mission-critical tasks, a progress of the mission-critical tasks, and a type of the project associated with the mission-critical tasks; and
display the information as a presentation of the mission-critical tasks on a project management interface of a display device.

4. The computing device of claim 1, wherein the resource management engine is further configured to:
compute a threshold to determine if the resources meet the predefined qualifications for the mission-critical tasks, wherein the predefined qualifications include one or more of: certifications to complete the mission-critical tasks and a prior history of completing the mission-critical tasks.

5. The computing device of claim 4, wherein the resource management engine is further configured to:
in response to a determination that the resources meet the predefined qualifications for the mission-critical tasks,
detect an assignment of the resources to the mission-critical tasks during a time period;
prevent the assigned resources from being allocated to another task during the time period; and
prevent the assigned resources from overlapping with the other task during the time period.

6. The computing device of claim 4, wherein the resource management engine is further configured to:
in response to a determination that the resources fail to meet the predefined qualifications for the mission-critical tasks, release the resources from the mission-critical tasks.

7. The computing device of claim 6, wherein the resource management engine is further configured to:
in response to the release of the resources from the mission-critical tasks, transmit an alert to a display device to prompt the display device to present the alert, wherein the alert includes one or more of an audio alert, a visual alert, a tactile alert, and a textual alert.

8. The computing device of claim 1, wherein the resource management engine is further configured to:
detect a completion of a final task prior to completion of one of the mission-critical tasks; and
mark a milestone associated with the tasks as a failure, wherein the milestone is a point of transition from a first phase of the project to another phase of the project.

9. The computing device of claim 1, wherein the resource management engine is further configured to:
in response to detecting a delay in a performance of one of the mission-critical tasks, mark a milestone associated with the tasks as a failure.

10. A method executed on a computing device to provide project management with critical path scheduling and releasing of resources, the method comprising:
receiving tasks associated with a project;
detecting a subset of the tasks to be categorized as mission-critical tasks;
distinguishing information associated with the mission-critical tasks;
determining resources associated with the mission-critical tasks; and
evaluating the resources associated with the mission-critical tasks to determine if the resources meet predefined qualifications for the mission-critical tasks.

11. The method of claim 10, further comprising:
performing a verification process during an association of the resources with the mission-critical tasks to determine if a first resource associated with a first mission-critical task is additionally allocated to a second mission-critical task.

12. The method of claim 11, further comprising:
in response to a determination from the verification process that the first resource is allocated to the second mission-critical task, releasing the first resource from the second mission-critical task.

13. The method of claim 12, further comprising:
detecting a completion of a first mission-critical task; and
re-assigning the first resource to the second-mission critical task.

14. The method of claim 10, further comprising:
executing the mission-critical tasks in response to a determination that the resources meet the predefined qualifications.

15. The method of claim 10, further comprising:
enabling a stakeholder to move a first resource from a first mission-critical task to a second mission-critical task;
determining that the first resource meets the predefined qualifications;
receiving a notification of proposed consequences of a movement of the first resource to the second mission-critical task; and
in response to receiving an acceptance of the proposed consequences, executing the second mission-critical task.

16. The method of claim 10, further comprising:
enabling a stakeholder to release a first resource from a first mission-critical task based on a determination that the first resource fails to possess certifications to complete the first mission-critical task or includes a conflict that disallows the first resource from completing the first mission-critical task;
receiving a notification of proposed consequences of the release of the first resource from the first mission-critical task; and
in response to receiving an acceptance of the proposed consequences, releasing the first resource from the first mission-critical task.

17. The method of claim 10, wherein evaluating the resources associated with the mission-critical tasks includes determining that the resources meet from about 95% to about 100% of the predefined qualifications for the mission-critical tasks.

18. A computer-readable memory device with instructions stored thereon to provide project management with critical path scheduling and releasing of resources, the instructions comprising:
receiving tasks associated with a project;
detecting a subset of the tasks to be categorized as mission-critical tasks;
distinguishing information associated with the mission-critical tasks;
determining resources associated with the mission-critical tasks; and
evaluating the resources associated with the mission-critical tasks to determine if the resources meet predefined qualifications for the mission-critical tasks.

19. The computer-readable memory device of claim 18, wherein the instructions further comprise:
performing a verification process during an association of the resources with the mission-critical tasks to determine if a first resource associated with a first mission-critical task is additionally allocated to a second mission-critical task; and
in response to a determination from the verification process that the first resource is allocated to the second mission-critical task,
releasing the first resource from the second mission-critical task;
detecting a completion of the first mission-critical task; and
re-assigning the first resource to the second-mission critical task.

20. The computer-readable memory device of claim 18, wherein the instructions further comprise:
performing a verification process during an association of the resources with the mission-critical tasks; and
in response to a determination from the verification process that the resources meet predefined qualifications of the mission-critical tasks, assigning the resources to the mission-critical tasks.
